(19) United States
(12) Patent Application Publication
(10) Pub. No.: US 2023/0088090 A1
(43) Pub. Date: Mar. 23, 2023

(54) SYSTEM COMBINING MULTIPLE HYDROPONIC CULTURE METHODS

(71) Applicant: Edmond Reynolds McKean, Sanford, NC (US)

(72) Inventor: Edmond Reynolds McKean, Sanford, NC (US)

(21) Appl. No.: 17/945,929

(22) Filed: Sep. 15, 2022

Related U.S. Application Data
(60) Provisional application No. 63/246,123, filed on Sep. 20, 2021.

(51) Int. Cl. A01G 31/02

(52) U.S. Cl. CPC A01G 31/02

(57) ABSTRACT

A hydroponic system which combines four hydroponic systems into one system, which may include a Deep-Water Culture (DWC), a Nutrient Film Technique (NFT), an Aeroponic, and a Drip system. A frame holds and supports a grow tube structure. The grow tube structure is a multi-tiered tubular structure comprised of horizontally arranged tubes and vertically arranged tubes, where the horizontally arranged tubes are pitched at a downward angle. A pump delivers nutrient rich liquid to an upper end of the tubular structure from a reservoir which gravity flows to a lower end and returns to the reservoir. Valves are included in the tubular structure to adjust an amount of liquid within the tubular structure and a gravity flow of the liquid through the tubular structure. An oxygenation system oxygenates the liquid directly at the roots. Further a drip system slowly disperses water over each plant early in the maturation stage.

### CROSS-REFERENCE TO RELATED APPLICATIONS

This application is a non-provisional application which claims priority to U.S. Provisional Patent Application No. 63/246,123 filed on Sep. 20, 2021, which is incorporated by reference in its entirety.

### FIELD OF THE DISCLOSURE

The present invention generally relates to a hydroponic system used to grow plants, and more specifically to a combination of several hydroponic grow methods.

### BACKGROUND

Generally, most plants are grown in gardens and fields utilizing soil. By growing in a soil medium, plants can unfortunately be exposed to a host of factors that negatively impact their health and growth. Fungus present in the soil can spread diseases to the plants. The plants are also exposed to animals such as rabbits and snails which can ravage ripening vegetables on the plants. Other disastrous forces that can descend on the plants and obliterate them includes pests such as locusts. When a plant is grown in soil, its roots are constantly searching for the necessary nutrition to support the plant, such as water, oxygen, and other nutrients. Thus, the plant's roots expend energy to acquire food and water.

Hydroponics is an alternative to growing plants in soil. In the absence of soil, water goes to work providing nutrients, hydration, and oxygen to a plant. In a hydroponic system, the plants are often grown in an inert media which support the plant and anchor its root. By growing plants in a hydroponic system, some of the negatively impacting variables are taken out of the equation and the energy that the plant expends to acquire food and water in a soil can be redirected into the plant's maturation.

The practice of growing plants in a hydroponic system also has other benefits. Among some of the benefits include allowing large tracts of land to resort to their natural landscape and restore the ecosystem; optimizing space usage to grow more plants; creating a strategy for water conservation; allowing year-round food production without loss to weather related events or changes; and reducing or eliminating the use of pesticides and herbicides.

While indoor farming is not new, hydroponics improves on that phenomenon. Though there are many benefits to hydroponic farming, there are improvements that can be made to the system to overcome some challenges that are encountered with hydroponics. The present disclosure described herein addresses some of the challenges and improves on the hydroponic system.

### SUMMARY

The invention described herein provides for an improved means of growing plants in a hydroponic tube grow system, which will be referred to as a hydroponic system within this disclosure. One or more embodiments are provided below for a system adapted to accommodate multiple hydroponic systems into a single system. The present disclosure of the hydroponic system describes a multitiered tube system which may combine two or more hydroponic systems into one. In the one or more embodiments described herein, the hydroponic system combines four hydroponic systems into one system, which may include a Deep-Water Culture (DWC), a Nutrient Film Technique (NFT), an Aeroponic, and a Drip system.

The hydroponic system may be setup as a vertical scrog or a typical tube grow system which has one continuous gravity flood tube system fed by one water supply. The tube system comprising part of the hydroponic system may include gate valves which regulate the depth of the fluid in the tubes and ensure that a certain fluid level remains in the tube system if there is a loss of power or equipment failure and the flow of fluid through the tube system is paused. Thus, in such a situation, the tubes remain filled with nutrient rich fluid for the plants' roots to sit in until power to the hydroponic system is restored, ensuring that the roots do not die. The hydroponic system is fed at a top tube by a pump and then gravity feeds to the bottom tube and into a nutrient reservoir which gets recycled back to the top. The pitch of the tubes can also be adjusted so that the nutrient rich fluid can move fast or slow through the system depending on the pitch. Additionally, the tubes can also be angled towards a light source which may be set up above or within the tube system. The invention also provides for a system that is fully contained with a light source, and a tent system.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of a hydroponic system depicting a frame and a grow tube system in accordance with an illustrative embodiment

FIG. 2 is a side view of the hydroponic system in accordance with an illustrative embodiment.

FIG. 3 is a perspective view of only the grow tube system in accordance with an illustrative embodiment.

FIG. 4 is a perspective view of only the frame in accordance with an illustrative embodiment.

FIG. 5 is a block diagram of a hydroponic system in accordance with an illustrative embodiment.

### DETAILED DESCRIPTION

In the Summary above and in this Detailed Description, and the claims below, and in the accompanying drawings, reference may be made to particular features of the invention. It may be understood that the disclosure of the invention in this specification includes all possible combinations of such particular features. For example, where a particular feature may be disclosed in the context of a particular aspect or embodiment of the invention, or a particular claim, that feature can also be used, to the extent possible, in combination with and/or in the context of other particular aspects and embodiments of the invention, and in the invention generally.

Where reference may be made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” may be used herein to mean “serving as an example, instance, or illustration.” Any aspect described in this document as “exemplary” may not be necessarily construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

As used herein, the terminology such as vertical, horizontal, top, bottom, front, back, end, and sides are referenced according to the views presented or orientation of parts. It should be understood, however, that the terms are used only for purposes of description and are not intended to be used as limitations. Accordingly, orientation of an object or a combination of objects may change without departing from the scope of the invention.

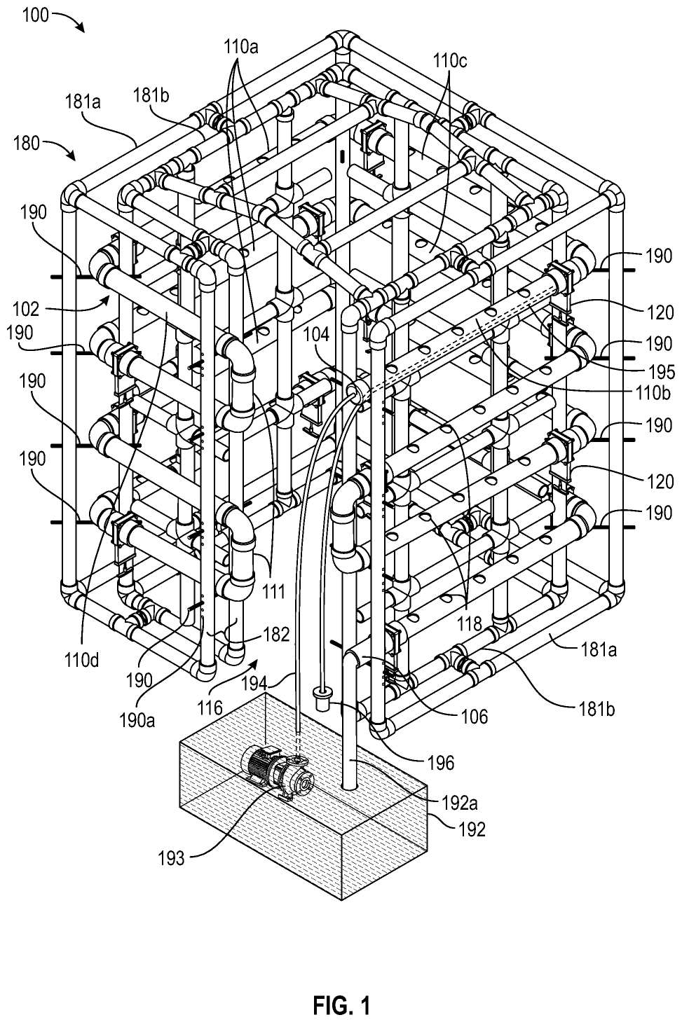

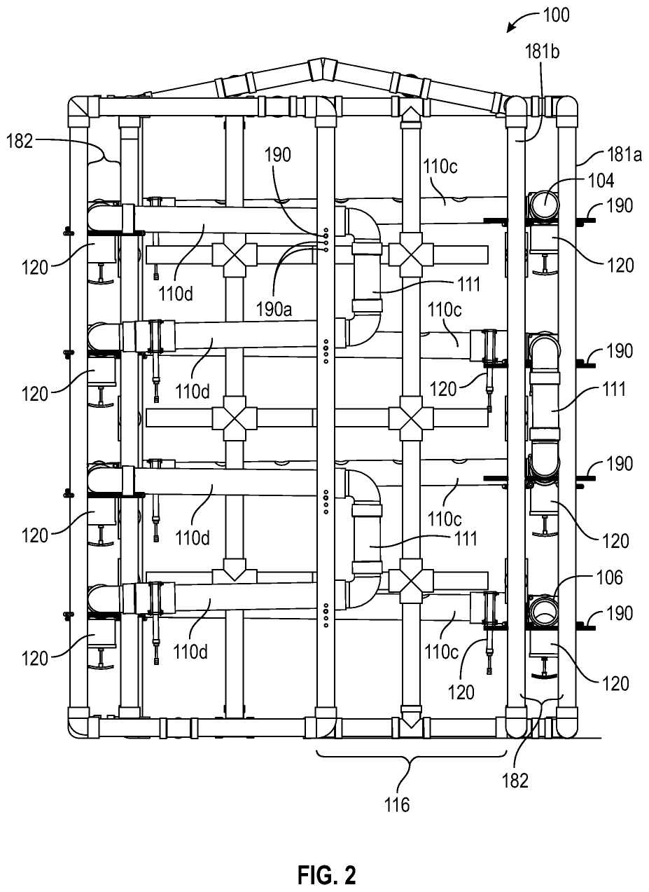

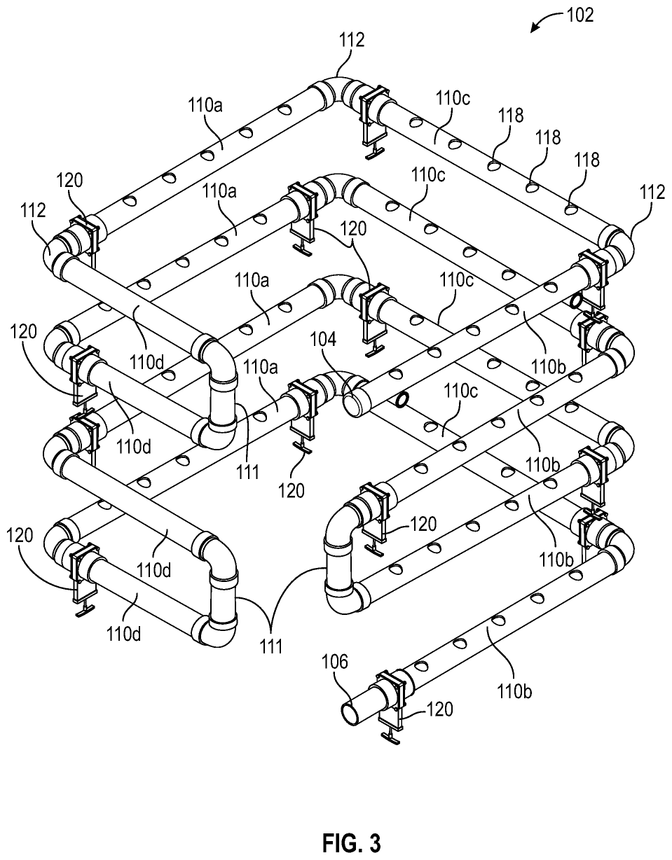

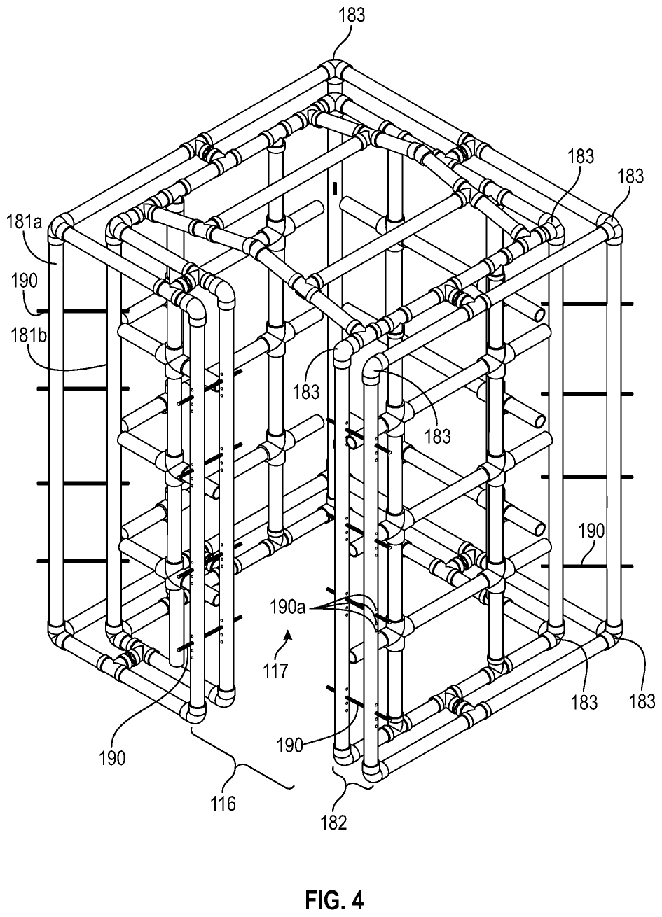

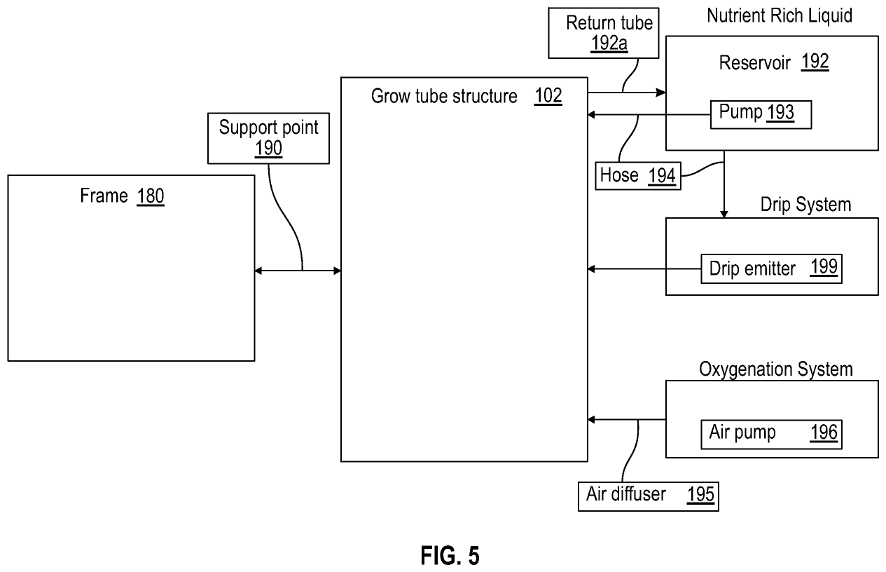

With reference to FIGS. 1 to 5, a hydroponic system 100 is presented in accordance with a non-limiting preferred embodiment of the present invention. FIGS. 1 and 2 are illustrations depicting a front view and a side view of the hydroponic system 100, respectively. FIG. 3 is a perspective view of a grow tube only. FIG. 4 is a perspective view of a frame only. FIG. 5 is a block diagram of the hydroponic system. The hydroponic system 100 is configured for cultivating plants in the absence of soil by combining several hydroponic grow methods into one system. The hydroponic grow methods combined into one hydroponic system 100 comprise of a deep-water culture (DWC), a nutrient film technique (NFT), an aeroponic system, and a drip system. The hydroponic system 100 is also configured to be adjustable and further provide a system that ensures a nutrient rich water supply is constantly available to roots of plants grown in the hydroponic system 100 in case of a power failure. The hydroponic system 100 may be utilized indoors and allows control over growing conditions. However, it is to be understood that the hydroponic system 100 may also be used outdoors.

In accordance with achieving this purpose, one such configuration and geometry is shown in the non-limiting embodiment of the hydroponic system 100, and it should be understood that other configurations and geometries are also within the realm of this disclosure. Referring to FIG. 1, the hydroponic system 100 is shown to be comprised of a grow tube structure 102 and a frame 180. The grow tube structure 102 which may also be referred to as a tubular structure 102, may be connected to and supported by the frame 180. A reservoir 192 may be connected to or otherwise provided at a lower end 106 of the grow tube structure 102. A pump 193 may be connected to a hose 194 that is connected to or otherwise provided at an upper end 104 of the grow tube structure 102 to supply liquid rich in nutrients within the grow tube structure 102. The pump 193 may be included in the reservoir 192 wherein the liquid is supplied to the grow tube structure 102 from the upper end 104 and gravity fed through to the lower end 106, at which point it is returned back into the reservoir 192 by a connected return tube 192a. An oxygenation system comprising an air diffuser 195 is also disposed within the tubular structure 102 to be submerged within the liquid flowing through the tubular structure 102. The air diffuser 195 is connected to an air pump 196 to oxygenate the liquid within the tubular structure 102.

As clearly shown in FIG. 2, the grow tube structure 102 of the hydroponic system 100 is a tubular structure which may be comprised of a plurality of horizontally arranged tubes (110a, 110b, 110c, and 110d), and a plurality of vertically arranged tubes 111 with several elbow joints 112. As shown in the non-limiting embodiment in FIG. 2, the grow tube structure 102 is a vertically arranged structure which allows a liquid to flow slowly through the system via gravity. As seen in FIGS. 1 to 3, the grow tube structure 102 is formed by sixteen tubes, comprised of several left side tubes 110a, several right side tubes 110b, several back-end tubes 110c, and several front-end tubes 110d that are arranged horizontally with a slight downward angle and connected to each other by the elbow joints 112. Referring to FIG. 2, which is a front side view of the hydroponic system 100, the downward angle of the tubular grow structure 102 is apparent, starting from an upper end 104 of the tubular structure 102 down to a lower end 106 of the tubular structure. This multi-tiered arrangement of the tubular grow structure 102 allows a nutrient rich liquid to be delivered at the upper end 104 is a starting point of where a nutrient rich liquid is delivered and the downward angle allows the liquid to flow through the tubular structure 102 to the lower end 106.

The grow tube structure 102 has a generally quadrilateral shape with an open interior 117 and is formed by having of a pair of opposing left side tubes 110a and right side tubes 110b that are positioned in approximate parallel spaced relation to one another, and a pair of opposing back-end tubes 110c and front-end tubes 110d that are positioned in approximate parallel spaced relation to one another. The left and right side tubes 110a, 110b are positioned in approximate perpendicular alignment to the back-end tubes 110c and the front-end tubes 110d. The left side tubes 110a, wherein each having two ends, are connected to the back-end tubes 110c and the front-end tubes 110d at each end by the elbow joints 112. In a similar fashion, the back-end tubes 110c, wherein each having two ends, are connected to the left side tubes 110a and the right side tubes 110b at each end by the elbow joints 112. In contrast, the right side tubes 110b, wherein each having two ends, are connected to the back end tubes 110c and to another right side tube 110b with the elbow joints 112 and the vertically tube 111. Similarly, the front-end tubes 110d, wherein each having two ends, are connected to the left side tubes 110a and to another front-end tube 110d with elbow joints 112 and the vertically arranged tube 111. Thus, the general arrangement of the grow tube structure 102 is a serpentine multi-tiered arrangement. Even though the general shape of the grow tube structure 102 is a quadrilateral, it is to be understood that any shape may be used including and not limited to a circle, triangle, and oval.

In the arrangement shown in FIGS. 1 to 4, an opening 116 is shown to an open interior 117 of the grow tube structure 102. As clearly seen in FIG. 2, the opening 116 is formed between the front-end tubes 110d and the right side tubes 110b. The opening 116 allows access to the open interior 117 for a user to enter and attend to taking care and/or harvesting of plants. In the arrangement shown in these figures, the opening 116 is created by shortening a length of the front-end tubes 110d, such that the end that is bent downward or connected to the vertical tube 111 to then connect with another front end tube 110d to continue the flow and is not connected to the right side tubes 110b at the opening 116.

Included in the left side tube 110a, the right side tube 110b, and the back-end tube 110c, are a plurality of openings, referred to as tube openings 118. The tube opening 118 may be adapted to receive a plant to be grown in the grow tubes 102 of the hydroponic system 100. The plants will sit within the tube openings 118 such as to allow solutions to contact a plant's root system. As seen in FIG. 1 and FIG. 2, the front-end members 110d are not configured with the tube openings 118, however it is to be understood that the front-end members 110d may also be configured with the tube openings 118.

The grow tube structure 102 may be adjustably connected to the frame 180. The frame 180 provides a support structure to which the tubular elements of the grow tube structure 102 are connected to (e.g., see connection points 190). In FIGS. 1, 2, and 4, the frame 180 may also comprise of a plurality of tubes connected with elbow joints 183 The frame 180 is shown to comprise of two sections, an outer section 181a and an inner section 181b, which are connected together such as to leave a gap 182 between the two sections. The grow tube structure 102 is positioned within the gap 182 created between the outer section 181a and the inner section 181b of the frame 180.

The grow tube structure 102 may be supported to the frame 180 at several support points 190 on the frame 180. As seen in FIGS. 1 and 3, the support points 190 may be rods that are placed through holes 190a vertically arranged in the frame 180 at multiple locations which support the vertical arrangement of the grow tube structure 102. In particular, the holes 190a for the support points 190 are on both the outer section 181a and the inner section 181b and symmetrically placed such that the holes 190a arranged on each adjacent side of the outer and inner sections 181a, 181b match to allow each support point 190 to sit parallel to a floor the hydroponic system 100 is placed on. The support points 190 are arranged at each of a corner of the frame 180. Each of the support points 190 are vertically adjustable so that the tubular elements on the grow tube structure 102 may be positioned higher or lower depending on which holes 190a a single support point 190 is placed through to adjust the incline of each of the horizontal tubular elements (see e.g., 110a, 110b, 110c, and 110d) resting on the support points 190. The adjustability to the inclination allows the flow rate of the nutrient rich water to be adjusted to optimize the grow tube structure 102 for the plants grown in the hydroponic system 100.

The frame 180 also provides a structure to form an enclosed system which may include a screen and one or more lights. The screen may be positioned on an outside portion of the outer section 181a of the frame 180 and is used to provide an enclosed system similar to a tent. The inner section 181b of the frame 180 may be used to provide a support for a net or a scrog net. The one or more lights may be centered on a top portion of the frame 180 to provide sufficient light to the plants growing in the hydroponic growth system 100.

The frame 180 and the grow tube structure 102 are designed to be easily dismantled and then put together.

The hydroponic system 100 also comprises of valves 120 which regulate the nutrient flow and provide the needed flexibility to address any plant size or variety. The valves 120 are placed throughout the grow tube structure 102, and more specifically at the end of each tubular element (see, e.g., 110a, 110b, 110c, and 110d) which may have tubular openings 118 for receiving the plants. The valves 120 also allow flexibility to adjust the flow in each individual tubular element. Another advantage of the valves 120 placed within the tubular elements being that in the case of a power failure or a pump failure, the roots of the plants growing within the grow tube structure 102 will remain in fluid contact and help the plant survive until the power or pump issue is resolved.

A pump is operatively connected to a reservoir and serves to pump the nutrient rich water through the grow tube structure 102. The pump is any device that may move water through the grow tube structure. In one arrangement, the pump is positioned within the reservoir and submerged in the nutrient rich water. It is also to be understood that the pump may be external to the reservoir and fluidly connected to the reservoir. The pump has an outlet end which may be connected to the upper end 104 of the grow tube structure 102 via a hose (not shown) to pump water through the tubular structure 102 to return back to the reservoir 192 through the lower end 106.

The hydroponic growth system 100 also comprises a drip system which may include a drip emitter 199 (see FIG. 5). The drip system may be attached to an outside surface of each of the tubular structures 102 (see e.g., 110a, 110b, and 110c) in a location facing downward toward the openings 118 in the tubular element 102 (see e.g., 110a, 110b, and 110c) below. As mentioned above, the drip system may comprise the drip emitter 199 which is positioned above each individual opening 118, and thus each plant in the openings 118, having one drip emitter 199 or a thin tubing with small holes to emit fluid. Each individual plant gets at least one drip emitter 199 or in the case of the thin tubing at least one hole emitting fluid. The drip system may be connected to the water pump 193 via the hose 194 or a separate hose. The drip system may be ideal for a seedling or a young plant. Instead of running water through the grow tube structure 102, the drip system secretes the liquid in a slow dripping action. This ensures that the hydroponic system 100 uses much less water so as not to drown the seedlings or the young plants. Once the plants are mature, the drip system may be disengaged from the pump 193 by removing the hose 194. The hose 194 is connected to the upper end 104 of the tubular structure so the plants may now be grown with the roots submerged in the running nutrient rich liquid in the grow tube structure 102 being pumped from the reservoir 192. The drip system 102 may also be ideal for certain type of plants not limited to seedlings and young plants. Further, the drip system may be used to provide carbon dioxide to the plants as needed. Other uses that are foreseeably possible with the drip system are also to be understood to be a part of the disclosure.

As shown in FIG. 1, the oxygenation system is provided to oxygenate the liquid in the grow tube system 102. The oxygen may be supplied by several methods. One such example is use of the air diffuser 195 which is typically made of a bendable tube with holes that releases air into the liquid and ensures the root system is exposed to maximum oxygenation. The air diffuser 195 is disposed within the tubular structure 102 arranged from the upper end 102 to the lower end 106. FIG. 1 only illustrates a topmost right side horizontally arranged tube 110b in a transparent view to show the air diffuser 195. It should be understood that the air diffuser 195 is disposed throughout the entire tubular structure 102 as mentioned above. The air diffuser 195 is intended to be submerged within the liquid flowing through the tubular structure 102 to oxygenate the nutrient rich liquid provided to the plants.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A system for growing plants, comprising:
a vertically arranged multi-tiered tubular structure comprised of a plurality of horizontally arranged tubes and a plurality of vertically arranged tubes wherein the plurality of horizontally arranged tubes are pitched at a downward angle and comprise a plurality of tube openings wherein each tube opening of the plurality of tube openings is adapted to receive a plant;
a frame configured to support the vertically arranged multi-tiered tubular structure;
a pump connected to an upper end of the vertically arranged multi-tiered tubular structure is configured to pump a nutrient rich solution into the vertically arranged multi-tiered tubular structure; and
a reservoir containing the nutrient rich solution, wherein the pump is operatively connected to the reservoir to deliver the nutrient rich solution to the vertically arranged multi-tiered tubular structure.

2. The system of claim 1, wherein the plurality of horizontally arranged tubes and the plurality of vertically arranged tubes are connected in a serpentine arrangement such that the nutrient rich solution is delivered to the upper end of the vertically arranged multi-tiered tubular structure to gravity flow down to a lower end of the vertically arranged multi-tiered tubular structure to return the nutrient rich solution to the reservoir.

3. The system of claim 1, wherein the vertically arranged multi-tiered tubular structure forms a structure with an open interior, wherein the structure is arranged with an opening to access the open interior.

4. The system of claim 1, wherein the frame comprises of two adjacent sections, an outer section and an inner section, wherein the vertically arranged multi-tiered tubular structure is positioned within a gap between the outer and inner sections.

5. The system of claim 4, wherein support points on the outer section and the inner section support the vertically arranged multi-tiered tubular structure such that the plurality of horizontally arranged tubes are placed on a top of the support points.

6. The system of claim 5, wherein the support points are arranged through holes in the outer and inner sections such that the support points are parallel to a floor the system is arranged on.

7. The system of claim 1, wherein valves are included in each of the plurality of horizontally arranged tubes, wherein the valves are included to control an amount of nutrient rich solution within the vertically arranged multi-tiered tubular structure and a gravity flow of the nutrient rich solution through the tubular structure.

8. The system of claim 1, further comprising an oxygenation system where an air diffuser is disposed within the vertically arranged multi-tiered tubular structure to sit within the nutrient rich solution in the vertically arranged multi-tiered tubular structure to oxygenate the nutrient rich solution, wherein the air diffuser is connected to an air pump.

9. The system of claim 1, further comprising a drip system with a drip emitter placed above each of the tube openings in the vertically arranged multi-tiered tubular structure to slowly disperse nutrient rich solution over each of the tube openings, wherein the drip system is connected to the reservoir for the nutrient rich solution.

10. A system for growing plants, comprising:
a tubular structure vertically arranged in a geometric shape comprised of a plurality of horizontally arranged tubes and a plurality of vertically arranged tubes wherein the plurality of horizontally arranged tubes are pitched at a downward angle and comprise a plurality of tube openings wherein each tube opening of the plurality of tube openings is adapted to receive a plant;
a frame configured to support the tubular structure;
a pump connected to an upper end of the tubular structure and configured to pump a nutrient rich solution into the tubular structure; and
a reservoir containing the nutrient rich solution, wherein the pump is operatively connected to the reservoir to deliver the nutrient rich solution to the upper end of the tubular structure.

11. The system of claim 10, wherein the plurality of horizontally arranged tubes and the plurality of vertically arranged tubes are connected in a multi-tiered serpentine arrangement such that the nutrient rich solution is delivered to the upper end of the tubular structure to gravity flow down to a lower end of the tubular structure which returns the nutrient rich solution to the reservoir.

12. The system of claim 10, wherein the tubular structure forms a structure with an open interior, wherein the tubular structure is arranged with an opening to access the open interior.

13. The system of claim 10, wherein the frame comprises of two adjacent sections, an outer section and an inner section, wherein the tubular structure is positioned within a gap between the outer and inner sections.

14. The system of claim 13, wherein support points on the outer section and the inner section support the tubular structure such that the plurality of horizontally arranged tubes are placed on a top of the support points.

15. The system of claim 14, wherein the support points are arranged through holes in the outer and inner sections such that the support points are parallel to a floor the system is arranged on.

16. The system of claim 10, wherein valves are included in each of the plurality of horizontally arranged tubes, wherein the valves are included to control an amount of nutrient rich solution within the tubular structure and a gravity flow of the liquid through the tubular structure.

17. The system of claim 10, further comprising an oxygenation system where an air diffuser is disposed within the tubular structure to sit within the nutrient rich solution in the tubular structure to oxygenate the nutrient rich solution, wherein the air diffuser is connected to an air pump.

18. The system of claim 10, further comprising a drip system with a drip emitter placed above each of the tube openings in the tubular structure to slowly disperse nutrient rich solution over each of the tube openings, wherein the drip system is connected to the reservoir for the nutrient rich solution.

19. A system for growing plants, comprising:
a geometrically shaped multi-tiered tubular structure comprised of one or more left side horizontally arranged tubes, one or more right side horizontally arranged tubes, one or more back side horizontally arranged tubes, one or more front side horizontally arranged tubes, and a plurality of vertically arranged tubes, the one or more horizontally arranged tubes further comprising:
a plurality of tube openings wherein each tube opening of the plurality of tube openings is adapted to receive a plant; and
one or more valves configured to adjust a flow of a nutrient rich solution in the geometrically shaped multi-tiered tubular structure;
a frame configured to support the geometrically shaped multi-tiered tubular structure;
a pump connected to an upper end of the geometrically shaped multi-tiered tubular structure and configured to pump the nutrient rich solution into the tubular structure;
a reservoir containing the nutrient rich solution, wherein the pump is operatively connected to the reservoir to deliver the nutrient rich solution to the geometrically shaped multi-tiered tubular structure;
an oxygenation system comprising an air diffuser connected to an air pump, wherein the air diffuser is disposed to be submerged within the nutrient rich solution in the geometrically shaped multi-tiered tubular structure; and
a drip system connected to the pump in the reservoir, wherein the drip system includes a drip emitter placed above each tube opening.

20. The system of claim 19, wherein the plurality of horizontally arranged tubes and the plurality of vertically arranged tubes are connected in a serpentine arrangement with the plurality of horizontally arranged tubes having a downward pitch such that the nutrient rich solution is delivered to a top of the geometrically shaped multi-tiered tubular structure to gravity flow down to a bottom of the geometrically shaped multi-tiered tubular structure which returns the nutrient rich solution to the reservoir.
